(19) United States
(12) Patent Application Publication
(10) Pub. No.: US 2011/0002837 A1
(43) Pub. Date: Jan. 6, 2011

(54) ENHANCEMENT OF QUALITY AND QUANTITY OF CARBON NANOTUBES DURING GROWTH BY ADDITION OF MISCIBLE OXYGENATES

(76) Inventors: Morteza Maghrebi, Tehran (IR); Abbasali Khodadadi, Tehran (IR); Yadollah Mortazavi, Tehran (IR); Ali Sane, Tehran (IR)

Correspondence Address: CHOOBIN & CHOOBIN CONSULTANCY L.L.C;Barry Choobin, 18th Floor, Burjuman Business Tower, United Arab Emirates, 70307, AE

(21) Appl. No.: 12/830,359

(22) Filed: Jul. 5, 2010

Related U.S. Application Data
(60) Provisional application No. 61/287,270, filed on Dec. 17, 2009.

(51) Int. Cl. C01B 31/02

(52) U.S. Cl. 423/447.1; 977/843

(57) ABSTRACT

Disclosed is an experimental setup for synthesis of carbon nanotubes by floating catalyst method which comprises of a feeding and a reactor system. FIG. 1, illustrates CNT growth apparatus set up 100. The feeding system includes a syringe pump 115 for injecting of feed solution, liquid spraying, and or solid sublimation. The reactor system has a centrally located tubular quartz furnace 105, having a diameter of about 21.7 mm and divided into two zones.

### CROSS-REFERENCE TO RELATED APPLICATION

This application claims the priority under 35 USC 119(e) of U.S. Provisional Application Ser. No. 61/287,270 which is included by reference herein.

### BACKGROUND

1. Technical Field

The embodiments herein relate to a method of synthesizing carbon nanotubes (CNT) in a floating catalyst reactor in general and in particular to an enhanced method for growing CNT of using hydrocarbon feed and small amount of oxygenate/acetic acid with higher yield and less amorphous carbon deposition.

2. Description of the Related Art

Carbon nanotube (CNTs) is a relatively new material well-known for its novel properties such as extraordinary aspect ratio and exotic properties. Techniques employed to produce nanotubes in sizeable quantities, including arc discharge, laser ablation, high pressure carbon monoxide (HiPCO), and chemical vapor deposition (CVD) which is most common.

One of the recent branches of CVD is floating catalyst method. In this method a metal catalyst precursor (e.g., an organometallic substance and usually metallocenes) enters continuously along with a hydrocarbon and a carrier gas to instantly produce metal nanoparticles, which then catalyze the CNT synthesis.

In the course of CNTs synthesis by floating catalyst, there is a consensus about growth localization in a so-called “growth window” (GW). However, few researches have considered the variation of deposited products inside the window. Singh et al. had a short discussion about the thickness uniformity of CNTs array just across a small wafer. Nevertheless, a recent report briefly recognized longitudinal changes of CNTs along the reactor. In addition, it was demonstrated that changing the type of hydrocarbon feed can affects growth location. More recently, Chaisitsak et al. have reported some observations about the quality variation of non-array CNTs film in the cooling section, after the maximum temperature, of the reactor.

It is common in the floating catalyst researches to collect CNTs arrays grown on either the reactor inner wall, or small substrates. Regarding the former, one must make an unsupportive assumption that there is no longitudinal variation along the reactor.

Additionally, the surface of the reactor wall should not be considered unchanged for the successive experiments, as it shall be contaminated permanently by catalyst nanoparticles after just one run. On the other hand, the approach of putting a small substrate in a fixed point has a drawback, that it does not give an exhaustive picture of the deposition profile along the reactor. For instance, the variation of an examined parameter may show an increased growth rate at the position of substrate, while an interrelated decrease may also happen in the unwatched neighborhood. Jeong et al. have just recently exploited a “long wafer” approach. They used four long successive slabs and observed that CNTs arrays grow on all slabs but the two middle slabs showed neat and long CNTs growth.

In order, to have a comprehensive view of the whole growth window, we used the approach of “long wafer”. For more comprehensive comparison of CNT arrays, point to point characterization of the CNTs along the reactor is used. This allows for delicate comparison of CNTs having few differences in their synthetic parameters.

The floating catalyst method is not cost-effective and need more enhancements. Though the reactants are relatively inexpensive, the process heavily depends upon the labor work. Therefore, a more economically viable production method having optimized synthesis conditions is desired.

Prior art studies have shown that CNT growth starts rapidly, and it slows down gradually. Maintaining the initial growth rate to some extent significantly enhances the efficiency of the growth process. Prior art shows the CNT growth may be limited due to inhibition effects caused by pyrolytic amorphous carbon. Amorphous carbon was suggested to deactivate the catalyst seeds or just hinder diffusion of the reactants alongside the porous body of CNT array to the catalyst sites at bottom of the array. Thus any reduction in amorphous content could lead to the enhancement of catalytic growth. Beside the adverse effect of amorphous carbon on growth efficiency of CNTs, it is also an unfavorable impurity in many areas of CNT application, such as electrochemical biosensors.

Removal of amorphous carbon by purification method is an additional cost to its cutting/deterioration of CNTs. Therefore, prevention of amorphous carbon deposition during CNT synthesis is of much importance in terms of cost and quality.

The prevention of amorphous carbon formation is carried out by two approaches. First is the reduction of carbon supply to alleviate pyrolytic reactions but this can limit catalytic reactions of CNT growth. Second is the Selective inhibition/removal of amorphous carbon. The latter has the advantage of not restricting on the operational parameters of reaction, such as temperature and flow rates. So one may modify the CNT growth process significantly just by addition of some amounts of other compounds.

Traditionally researchers use hydrogen in the carrier gas to alleviate deposition of the amorphous carbon. However, hydrogen is relatively expensive for mass production and the required amount of hydrogen is almost high (say 10-100% of carrier gas). Hydrogen involves additional safety considerations too.

Recent researches have successfully employed oxygen or oxygen containing species to remove byproducts. Even small amount of gaseous oxygen can boost the CNT growth significantly thereby turning the entangled nanotubes to large dense arrays. Moreover, the published papers by Nishino et al., and Hata et al., have shown that water vapor could significantly enhance CNT growth. The CO₂ gas is also found to be helpful in catalytic growth of CNT through inhibiting amorphous carbon deposition. Nonetheless, the miscible (normally liquid) additives are more desired than immiscible ones, as they do not need an independent flow meter and can simply be incorporated to the injected feedstock in desired concentrations. However, they are rarely incorporated along with main feedstock.

There are some reports about efficient growth of CNT, using oxygenates, like ethanol and camphor, instead of common feedstock. While the growth rate and CNT quality were promising, one cannot rationally compare/optimize the results in term of oxygen content, because of different operational parameters employed. The floating catalyst method is so sensitive and complicated process that one may reach opposite results upon substitution of hydrocarbon feedstock. Therefore, it is hard to optimize the growth process. Here, by adding few mole percent of oxygenates, the deviation of other process parameters could be negligible or acceptable. So, one can try the oxygenate content as an almost independent parameter on an already-optimized set of operational parameters in a CNT growth process. Oxygenates could alleviate amorphous carbon and other pyrolytic byproducts. They can enhance combustion in car engines, preventing formation of the soot and heavy aromatic compounds.

### OBJECTIVE AND SUMMARY

A primary objective of the embodiments herein is to provide an enhanced CNT synthesis process.

Another objective of the embodiments herein is to provide a CNT of high quality and quantity.

Yet another objective of the embodiments herein is to enhanced high quality CNT with limited carbon amorphous deposition.

Further objective of the embodiments herein is to use oxygenate preferably acetic acid in small amount to prevent amorphous carbon deposition.

Yet another objective of the embodiments herein is to provide a process for producing carbon nanotubes comprising a heating system, a reactor and a feed stream containing a carrier, a carbon source, a catalyst source, an oxygenate or any combination thereof.

Yet another objective of the embodiments herein is to provide a process, wherein said carrier is an inert, a reducing, an oxidizing gas, or a combination thereof.

Yet another objective of the embodiments herein is to provide a process, wherein said carbon source is a compound of hydrocarbon, naphthenic, aromatic, carbon monoxide, or a combination thereof.

Yet another objective of the embodiments herein is to provide a process, wherein said oxygenate is an alcohol, an organic acid, ester, ether, ketone, CO₂, H₂O, O₂ or a combination thereof.

Yet another objective of the embodiments herein is to provide a process, wherein said metal complex is a metallocene, an organometallic, a metalorganic compound of iron, cobalt, nickel, palladium, platinum, ruthenium, or a combination thereof.

Yet another objective of the embodiments herein is to provide a process, wherein said heating system comprises of up to 4 heating sections of vaporizing in the range of 25-600° C., preheating in the range of 25-800° C., reaction in the range of 600-1200° C., and cooling in the range of 800-250° C.

### BRIEF DESCRIPTION OF THE DRAWINGS

FIG. 1 shows a block diagram of a reactor for producing CNT arrays according to one embodiment.

FIG. 2 shows the detailed topography of CNT arrays along the reactor, measured by optical microscopy, for AAO, AAI, and AA2 samples. The arrays shorter than −03 mm were neglected.

FIGS. 3 (a), (b) and (c) show the SEM micrographs depict morphology of CNT arrays respectively at the beginning, middle and end of GW of AAO sample, while FIGS. 3(d), (e) and (f) show the SEM micrographs depict morphology of CNT arrays respectively comparing with counterpart points of AA2 sample (d-f).

FIG. 4 shows a detailed variation of averaged diameter of CNTs along the GW of AAO, AAI, and AA2 samples, based on SEM results.

FIG. 5 shows a longitudinal variation of the intensity ratio of the 0- to G- band (Ir/Ic) corresponding to AAO,AAI, and AA2 samples along their GWs.

FIG. 6 shows the X-ray diffraction patterns of AAO and AA2 samples at middle and end of GWs, also showing full width at half maximum of C(002) peak.

FIGS. 7 (a) and (b) show the High resolution TEM micrographs of CNTs grown on the middle of GWs of AA2 and AAO samples.

FIG. 8 shows the growth indexes of all CNT array samples, calculated through multiplying average growth height by the width of growth window.

FIGS. 9 (a),(b) and (c) show the typical FESEM images depict CNTs morphology resulted from feeds with 0.0 (a), 1.0 (b) and 2.0% (c) acetone. FIG. 9 (d) shows the typical Raman results of CNT samples synthesized by addition of 2% of any of oxygenates to the base feed. FIG. 9 (e) shows the intensity ratio of the D- to G-band (ID/IG) of all CNTs samples versus their corresponding averaged diameter, based upon FESEM results.

### DETAILED DESCRIPTION OF THE EMBODIMENTS

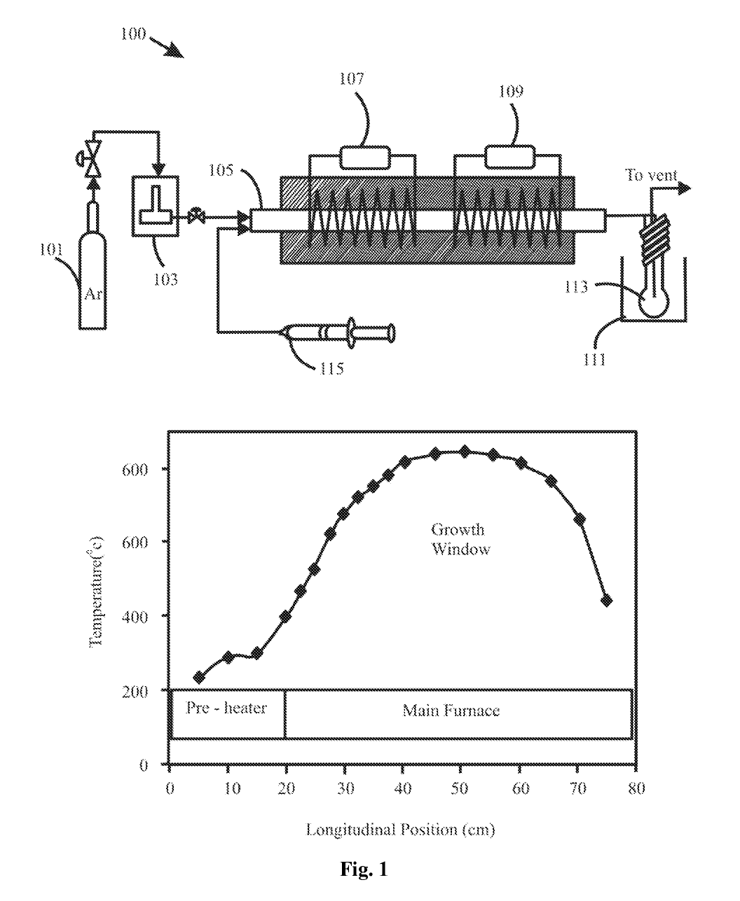

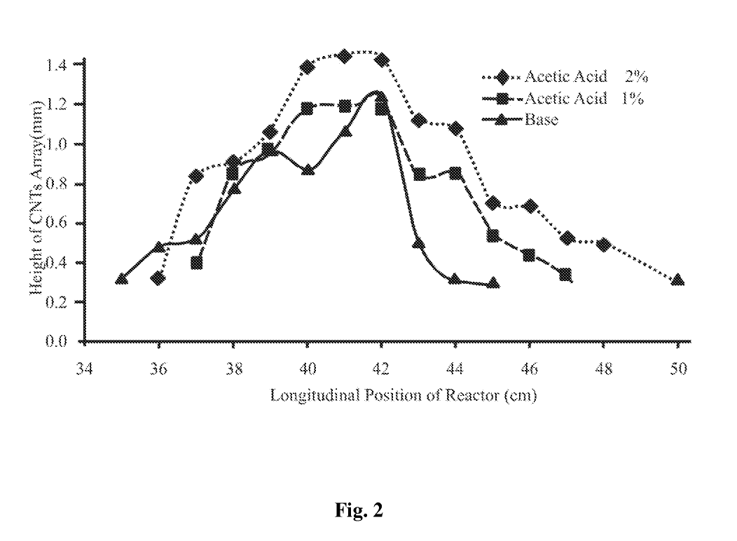

The experimental setup for synthesis of carbon nanotubes by floating catalyst method comprises of a feeding and a reactor system. FIG. 1, illustrates CNT growth apparatus set up 100. The feeding system includes a syringe pump 115 for injecting of feed solution, liquid spraying, and or solid sublimation. The reactor system has a centrally located tubular quartz furnace 105, having a diameter of about 21.7 mm and divided into two zones. First zone is referred to as pre-heater zone 107 and second zone is referred as heater zone 109. The diameter of the quartz tube can be varied depending on the requirement of CTN synthesized. FIG. 2 shows the location of growth window in the reactor. In addition set is provided with a collector 113 for condenser vapors and an ice bath 111. The reactor is provided with an inert gas supplier 101 for supplying an inert gas and MFC 103.

In one embodiment herein, the use of acetic acid is novel and enhances the CNT synthesis with limited amorphous carbon deposition. Experimental range of acetic acid is around 0.1-5 mole percent. The hydrocarbon feed used in present invention includes but not limited to gaseous/liquid/solid hydrocarbon, for examples, acetylene, ethylene, ethanol, hexane, aromatics. In one of the embodiment xylene is used as main feedstock, with few mole percent of selected oxygenates. The examples of oxygenate includes but not limited to camphor, phenol, acetone, methanol, preferably acetic acid, camphor, acetone, or phenol and more preferably acetic acid.

The feed mixture of a hydrocarbon (e.g., xylene, ethanol, hexane, acetylene, etc.) containing 0.01-0.9 g/ml of a catalyst metal precursor which includes but not limited to, any salts, organometallic of any transition metals preferably of Fe, Ni, Co or their inorganic salts). Few mole percent of oxygenates added to the abovementioned feed mixture/solution, in order to enhance growth rate of CNTs and reduce amorphous carbon formation. 200-5000 sccm of inert gas is introduced into reactor using a How controller. In one embodiment herein, argon gas with flow rate of 200-1500 cm³/min is used as per requirement. The flow rate can be scaled up. The carrier gas can be any other inert gas or a reducing gas such as hydrogen, CO or even oxidizing gases such as Oxygen or CO₂.

The first and the second zone of quartz tube are heated from room temperature −350° C. and 700-1250° C., respectively. The feed is preheated/evaporated in the first zone.

The substrate for CNT growth could be quartz or other ceramic/oxide materials in the form of rod, sheet, or even the reactor wall. Following the injection of feed, the reactor was cooled to room temperature under an inert atmosphere. The samples of CNTs collected at different longitudinal positions, is characterized by optical microscopy for quantity evaluation, and by Raman spectroscopy, scanning electron microscopy, X-ray diffraction, and high resolution transmission electron microscopy for quality evaluation (amorphous carbon content).

### Characterization Details

The samples of CNT arrays collected at specific longitudinal positions, is characterized by optical microscopy (Olympus BX 51), micro-Raman spectroscopy (WITec TS-150), and field emission scanning electron microscopy (JEOL JSM 6340F). A few selected CNT samples were also characterized by X-ray diffraction (Shimadzu 6000) and high resolution transmission electron microscopy (JEM-201OF).

The optical microscope used to measure the CNT arrays heights along the CNT growth zone on the quartz rod. The micro-Raman is operated with a 488 nm laser of 1.2 um spot size with an acquisition time of 30.0 s and a laser power of 3.0 mW. Raman spectra for at least 6 different positions of CNT sample on each piece of the quartz rod were obtained. X-ray diffraction (XRD) studies were employed overnight (0.1°/min scan rate), under 50 kV and 50 mA working conditions. For transmission electron microscopy (TEM) studies, CNT arrays sample are dispersed in acetone by 90 min sonication and the suspension was then applied on the carbon-coated copper grid. For all characterizations (except for XRD), CNT arrays were been studied from the side view, preferentially in the height middle of array, to disregard likely irregular/amorphous structures in the top/bottom of array.

The yellow-brownish tar-like substance condensed on the cool end of the reactor and in water-cooled steel condenser is collected. These samples are washed in dicholoromethane and dried in a vacuum over night. The weighted resultant solid residue is re-solublized in acetonitrile. High performance liquid chromatography (HPLC) measurements done on a HP Agilent 1100 equipped with a 4.6×250 mm ZORBAX Eclipse C-18 column (particle size: 5 μm). The HPLC method employed on each sample is as follows: injecting volume of 20 ul, into HPLC unit; setting the wavelength detection at 254 nm and acetonitrile:water (60/40 v/v) as mobile phase at 1 ml/min for 120 min. Throughout all the handlings and experimental procedure, the materials were protected in UV-shielding bottles and in cool environments. The HPLC spectra qualitatively compared with the standard mixture of polycyclic aromatic hydrocarbons (PAHs) in acetonitrile (Supelco, catalog no. 47940-U).

### Example 1

The employed liquid feed solutions of xylene contains 0.1 g/ml ferrocene as well as 0.0, 1.0, and 2.0 mole percentage of acid acetic, named AAO, AAI and AA2, respectively. The syringe pump injects the feed into the reactor at rate of 0.1-0.5 ml/min along with an argon flow rate of 500-1200 sccm. The reactor system with two zones, first one at the entrance of the reactor followed by second zone are heated to 300° C. and 700-850° C., respectively. The mm-long CNT arrays were grown on a 50-cm long quartz rod, put at the middle of the reactor. The length of the CTN (mm) depends on the synthetic parameters and upon axial location along the reactor. The height of base sample according to example 1 was about 1.2 (FIG. 1), which can be further enhanced to ˜1.4 mm by addition of 2% acetic acid.

As shown in FIG. 1, the AAI and AA2 have relatively larger array heights along the GW compared to those of the AAO sample. The maximum array height of the AA2 is ˜17% higher than that of the AAO sample. Similarly, the weight of CNT products of the AA2 sample was revealed to be ˜22% higher than that of the AAO sample. Thus, one can conclude that acetic acid has a positive effect on the total growth rate averaged along the GW.

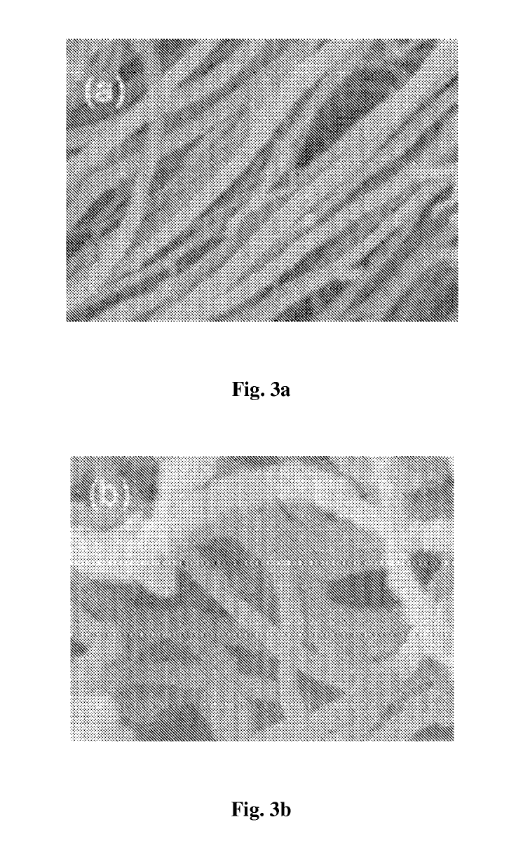

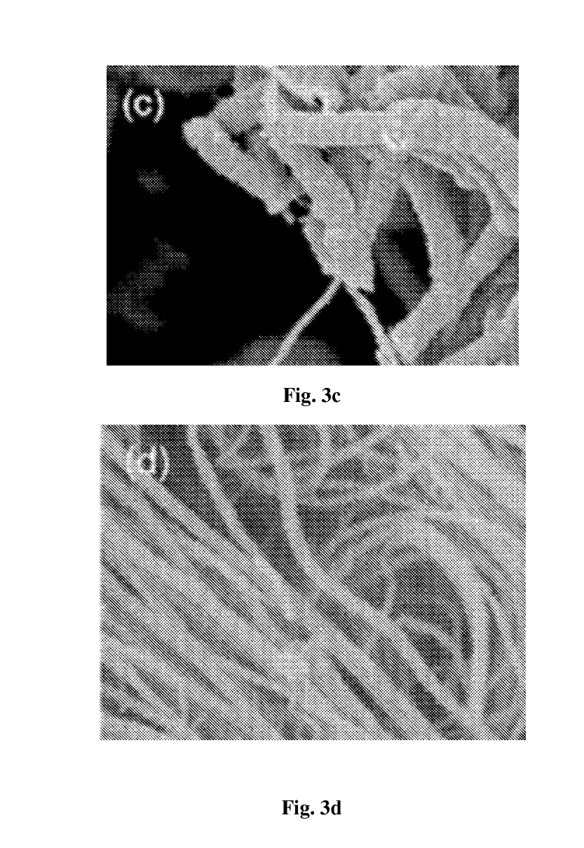

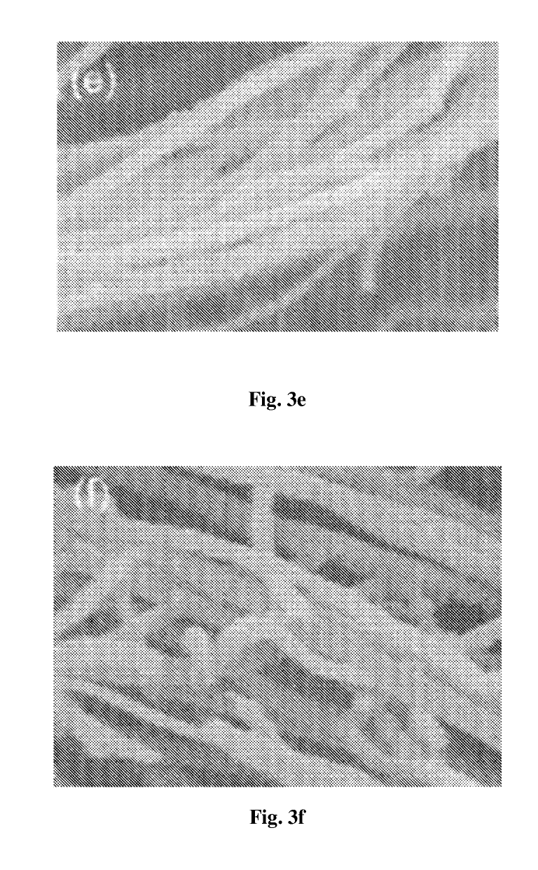

FIGS. 2a-2c illustrate typical scanning electron microscopy (SEM) images of the AAO sample in different longitudinal positions. Surface morphology and thickness was analyzed by SEM. CNTs are relatively thin and well-ordered at the beginning of GW (FIG. 2a). However, they gradually lose their quality/order and bumpy surfaces are obtained farther along the GW (FIG. 2b). The thickening with irregular coating is so severe near the end of GW that it seems some tubes are partially consolidated (FIG. 2c). One can also observe some CNT tips partially peeled from a thick and brittle coating of amorphous carbon. Similar to the AAO sample, the AA2 samples showed similar trend in quality worsening and thickening along the GW, but with slower pace (FIGS. 2d-2f). While the AAO and AA2 samples have relatively similar morphologies at the beginning of GW, the latter can keep its order and neatness more than the former toward the end of GW. Furthermore, the detailed microscopy observations revealed a continuous trend toward higher diameters for all CNT samples throughout the GW, while acetic acid supplement decelerate the trend of deposition of amorphous carbon significantly (FIG. 3).

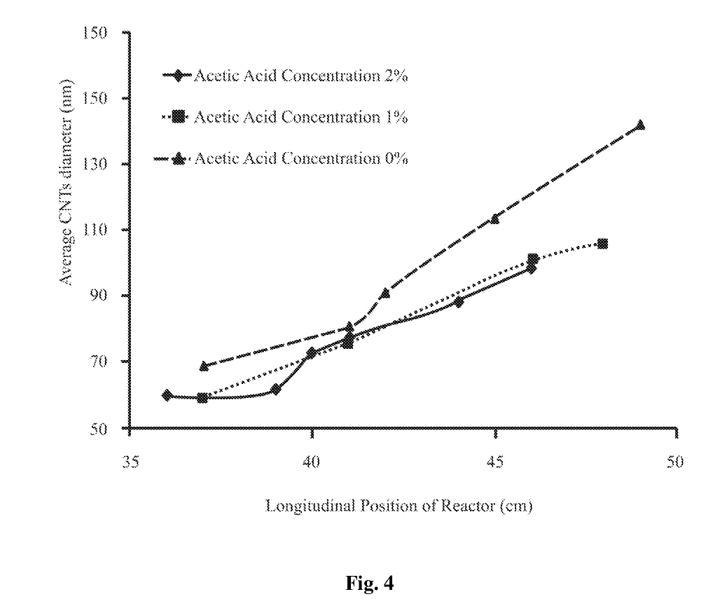

Raman spectra of AAO sample at various axial positions presented in FIG. 4a, show characteristic D- and G-bands around 1380 and 1590 cm⁻¹ respectively. As shown, the relative increase of D- to G-band along the GW, presenting more amorphous/imperfect structures near the end of growth profile.

FIG. 4b depicts the averaged I_{D}/I_{G} results, calculated from Raman spectroscopy of all samples along the reactor. Evidently, the general trend for all samples reveals an increase in I_{D}/I_{G} of carbon products along the GWs. This shows continuous rising of amorphous/imperfect structures along the GWs. Nonetheless, acetic acid lowers the deposition of amorphous/imperfect structures; while all the samples have near the same I_{D}/I_{G} ratios at the beginning of GW, the higher amount of acetic acid, the lower I_{D}/I_{G} ratios around the middle and end of GW. On the whole, the effects of acetic acid concentration are in good agreement with SEM results (FIGS. 2 and 3). Based on all the above findings, one may attribute the increased I_{D}/I_{G} ratios to thickening of CNT arrays by amorphous carbon overcoats.

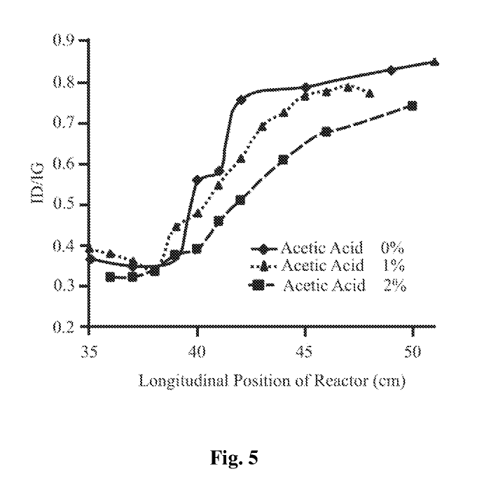

FIG. 5 shows X-ray diffraction patterns of the AAO and AA2 samples in two different axial locations of GW. The XRD spectra show that both samples have a quite strong peak at around 2θ=26°, known as belonging to graphite (002) plane and is related to crystallinity of the graphitic layers [41]. From FIG. 5, it is clear that at the same longitudinal positions, the peak at 2θ=26° of the AA2 sample has less full width at half maximum (FWHM) than the AAO sample, indicating higher crystalline structure of the former. However, FWHM of both samples increase along the longitudinal positions indicating a drop in crystallinity of the carbon structures from middle toward the end. These findings confirm SEM and Raman spectroscopy results presented in FIGS. 2-4.

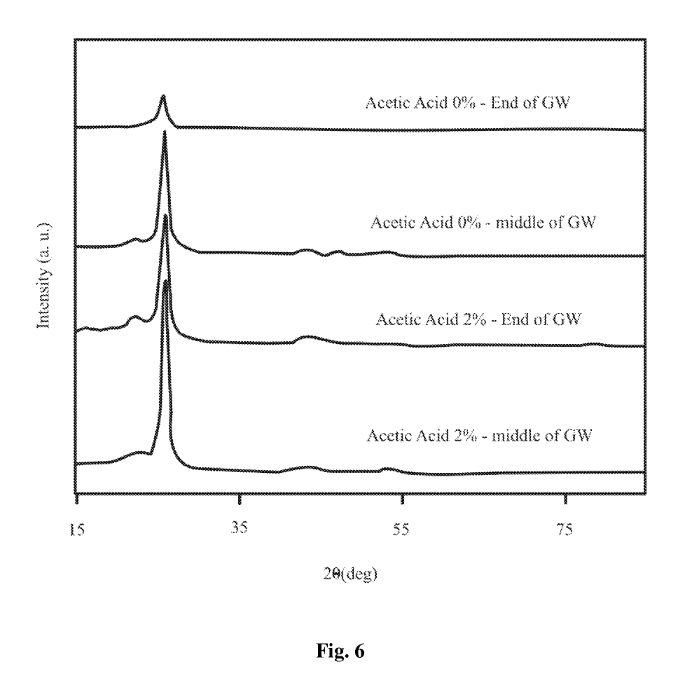

FIG. 6 illustrates high-resolution TEM micrographs of CNTs grown at the middle of GW of the AAO and AA2 samples. TEM was employed to analyze the structure of CNT. The AA2 sample (FIG. 6a) comprises several graphene layers, with few amorphous/irregular structures on the outer wall. On the other hand, AAO sample (FIG. 6b) includes fewer graphitic walls, covered by a thick amorphous coating. The less amorphous coating of the AA2 sample compared to that in AAO sample confirms the results obtained by SEM and Raman spectroscopy, i.e. FIGS. 2-4. The larger number of graphene walls of AA2 sample compared with corresponding image of the AAO sample is also in accordance with XRD results, i.e. FIG. 5, showed more crystalline carbon in the former. It may also points to a more competitive catalytic deposition in the AA2 sample, which not only results in longer CNT arrays (FIG. 1a), but also thicker graphitic layers. All above findings consistently demonstrate, that acetic acid additive reduce amorphous carbon impurity and increase CNT quantity, in terms of array heights and number of graphitic layers.

### Example 2

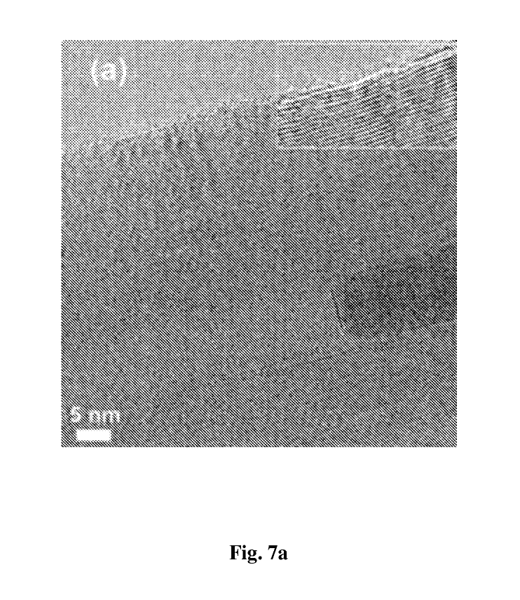

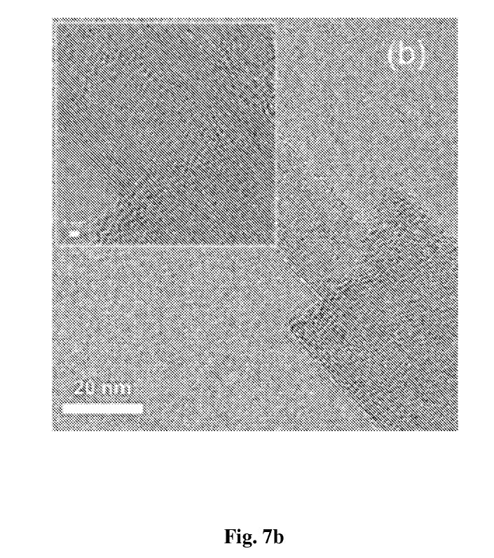

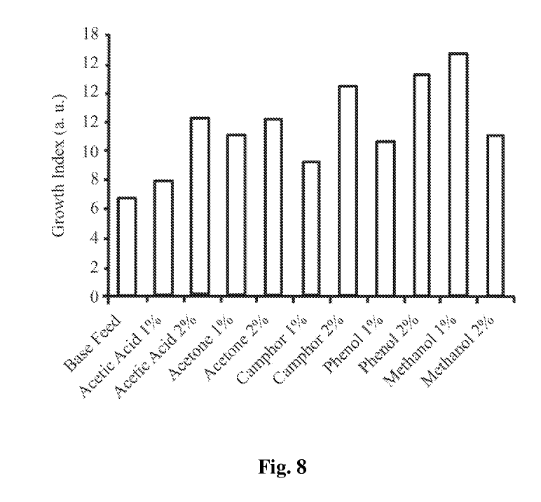

All the experimental details remain same as that of Example 1, except using 4 different oxygenates (camphor, phenol, acetone, methanol) instead of acetic acid. To compare the different height profiles more clearly, the “growth index” was defined. Growth index calculated for each sample by multiplying the average growth height by the width of growth window (GW). The CNT array at the position of maximum array height was characterized by micro-Raman spectroscopy and field emission scanning electron microscope. Both of these techniques were applied approximately. on mid height of the arrays, as a representative position. The height profiles of CNTs synthesized by 0.0, 1.0 and 2.0% camphor are depicted in FIG. 7a, while the growth indexes of all the samples are displayed in FIG. 7b. Obviously, the addition of each oxygenate to base feed solution increases the growth index. The exception is methanol, where 1.0% addition resulted in highest growth index, even than the sample with 2.0% of methanol

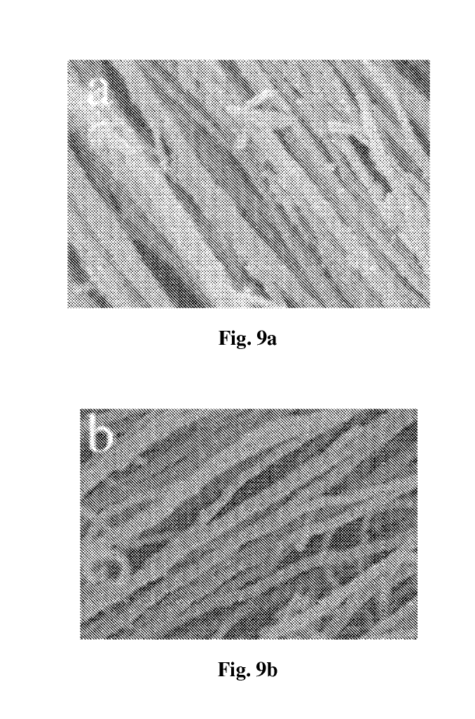

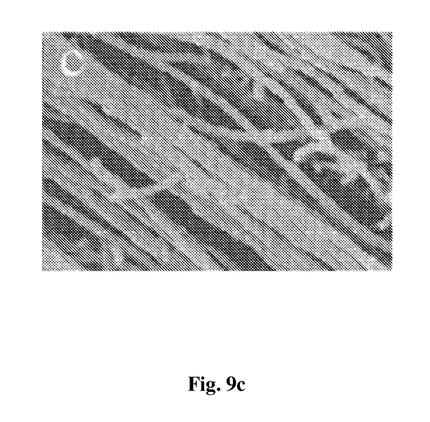

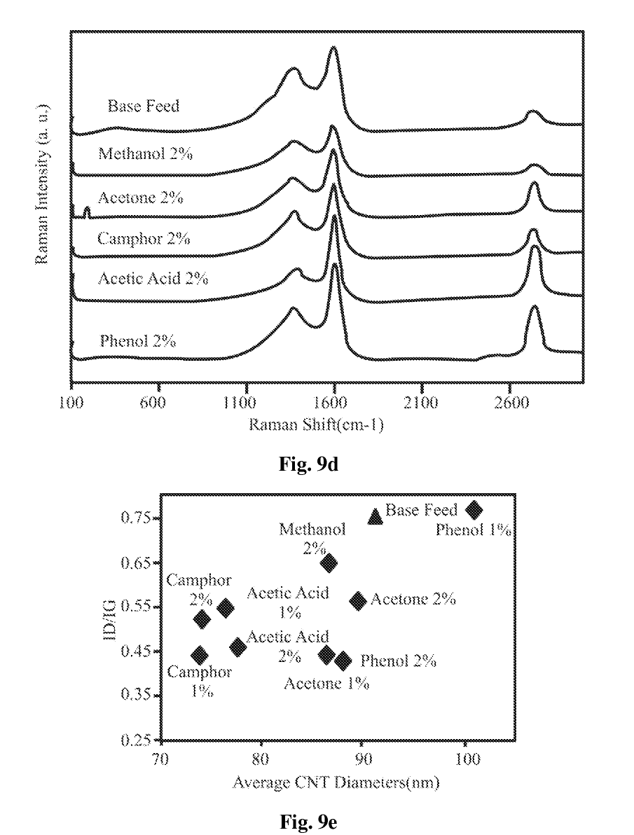

FIGS. 9a-c show FESEM images of the CNT samples synthesized with 0.0, 1.0 and 2.0% acetone. FIG. 9d presents Raman spectra of some of the samples, showing a decrease in ID/IG ratio as a result of adding 2.0% oxygenates to the base feed. FIG. 9e shows the relation of ID/IG ratios versus average CNT diameters for each sample. One can see that almost all oxygenate-containing samples have smaller ID/IG ratios as well as average CNT diameters than theoxygenate-free (base feed) sample. The exception is phenol 1.0%, where ID/IG ratio has not changed in comparison to the corresponding value for the basefeedstock. This finding suggests that oxygenates suppress the formation of amorphous carbon deposited on CNTs. Again, these findings consistently demonstrate, that acetic acid additive reduce amorphous carbon impurity and increase CNT quantity (i.e., array height).

We claim:

1. An enhanced method of synthesizing carbon nanotubes consisting the steps of:
introducing a feedstock solution into a reactor, wherein the feedstock solution comprises: hydrocarbon, catalyst metal precursor, acetic acid and oxygenate, wherein said hydrocarbon is selected from a group comprising: xylene, acetylene, ethylene, ethanol, hexane, wherein said catalyst metal precursor is organometallic of a transition metal and selected from a group consisting of iron, nickel, ferrocene, cobalt and their salts, and wherein the oxygenate is selected from a group consisting of: camphor, phenol, acetone, methanol;
supplying carrier gas;
selectively and locally heating the feedstock in the reactor; and growing carbon nanotubes.

2. A method as claimed in claim 1 wherein the feedstock solution to be supplied into the reactor is loaded into a feeding system, wherein said feeding system further comprises a syringe pump.

3. A method as claimed in claim 1, wherein said hydrocarbon in said feedstock solution forms the carbon source for CNT synthesis.

4. A method as claimed in claim 3, wherein said carbon source for CNT growth further comprises quartz wall of the reactor.

5. A process for producing carbon nanotubes comprising a heating system, a reactor and a feed stream containing a carrier, a carbon source, a catalyst source, an oxygenate or any combination thereof.

6. The process as claimed in claim 1, wherein said carrier is an inert, a reducing, an oxidizing gas, or a combination thereof.

7. The process as claimed in claim 1, wherein said carbon source is a compound of hydrocarbon, naphthenic, aromatic, carbon monoxide, or a combination thereof.

8. The process as claimed in claim 1, wherein said oxygenate is an alcohol, an organic acid, ester, ether, ketone, CO₂, H₂O, O₂ or a combination thereof.

9. The process as claimed in claim 1, wherein said metal complex is a metallocene, an organometallic, a metalorganic compound of iron, cobalt, nickel, palladium, platinum, ruthenium, or a combination thereof.

10. The process as claimed in claim 1, wherein said heating system comprises of up to 4 heating sections of vaporizing in the range of 25-600° C., preheating in the range of 25-800° C., reaction in the range of 600-1200° C., and cooling in the range of 800-250° C.

11. The process as claimed in claim 1, wherein said growing carbon nanotubes occurs on a substrate or a powder of quartz, metal, oxide, ceramic, carbon material, or a combination thereof.
